(19) United States
(12) Patent Application Publication
(10) Pub. No.: US 2022/0307550 A1
(43) Pub. Date: Sep. 29, 2022

(54) Bearing Holder for Receiving a Bearing

(71) Applicant: Efficient Energy GmbH, Feldkirchen (DE)

(72) Inventors: Johannes LANG, München (DE); Adrian ZAJAC, München (DE)

(21) Appl. No.: 17/835,162

(22) Filed: Jun. 8, 2022

Related U.S. Application Data
(63) Continuation of application No. PCT/EP2020/084877, filed on Dec. 7, 2020.

(30) Foreign Application Priority Data
Dec. 11, 2019 (DE) 10 2019 219 361.7
Aug. 13, 2020 (DE) 10 2020 210 331.3

(51) Int. Cl. F16C 27/06; F16C 19/52; F16C 27/04; F16C 35/077

(52) U.S. Cl. CPC F16C 27/066; F16C 19/527; F16C 27/04; F16C 35/077

(57) ABSTRACT

A bearing holder includes an inner portion and an outer portion, wherein the inner portion includes a receiving contour for receiving the bearing and the outer portion is configured to be mounted on a housing. A transition area between the inner portion and the outer portion includes a spring. The transition area is at least partly in a plane perpendicular to an axial axis of the receiving contour and is at least partly in a plane with at least one part of the inner and the outer portion. The transition area includes an attenuator and the attenuator is configured to attenuate a vibration of the inner portion to reduce a transfer of the vibration from the inner portion to the outer portion. Further, an electric motor, a method for producing a bearing holder and a method for operating a bearing holder are described.

### CROSS-REFERENCE TO RELATED APPLICATIONS

This application is a continuation of copending International Application No. PCT/EP2020/084877, filed Dec. 7, 2020, which is incorporated herein by reference in its entirety, and additionally claims priority from German Applications Nos. DE 10 2019 219 361.7, filed Dec. 11, 2019, and DE 10 2020 210 331.3, filed Aug. 13, 2020, which are all incorporated herein by reference in their entirety.

The present invention relates to a bearing holder for receiving a bearing, which can receive a rotor of an electric motor, wherein such an electric motor is used as compressor motor in heat pumps that is operated with water as operating liquid.

### BACKGROUND OF THE INVENTION

FIG. 1 shows a bearing holder known from DE 10 2016 203 411 A1. The bearing holder is supported on a motor housing by means of a spring arrangement (not shown). The spring arrangement is configured to allow a tilting deflection of the bearing holder with respect to the motor housing around at least one, advantageously around two tiling axes that are perpendicular to an axis of the motor shaft, while translatory deflection in the direction of the motor shaft is advantageously impeded or prevented. Thereby, due to the spring arrangement, the bearing portion can yield to the tiling of the motor shaft so that the same can rotate on its axis of inertia. Thereby, no continuous additional force acts on the bearing, as the entire bearing holder is deflectable.

Further, the bearing holder is not only coupled to the motor housing with a spring arrangement but also with an additional attenuation arrangement. This ensures that vibrations of the bearing holder with respect to the motor housing that are undesirable, i.e., that would result in a resonance step-up are prevented or resonances are attenuated. In particular, in the event of an impact on the motor, the attenuation system is useful to bring the motor shaft back to its axis of inertia in a relatively fast manner. Further, the attenuation system has proven particularly useful when starting up the motor when the motor shaft is driven through the rigid body resonances.

The bearing holder 10 of DE 10 2016 203 411 A1 comprises an outer portion 20 and an inner portion 30 as well as a spring arrangement 40. Further, the spring arrangement 40 comprises two or more spring legs 50 distributed equally across the circumference of circle. The attenuation system (not shown) is implemented by one or several elastic attenuation elements, such as O-rings that are continuously “rolled through” due to the tilting deflection of the bearing holder with respect to a motor housing, such that the bearing holder can actually dissipate energy based on vibration via the work done at the attenuation element.

FIG. 1 shows that the spring arrangement 40 of the bearing holder 10 comprises two or more longitudinal springs 15, wherein the spring legs each comprise a spring portion extending parallel to the axis of a motor shaft (not illustrated).

U.S. Pat. No. 8,282,285 B2 discloses a bearing holder comprising a structure extending in circumferential direction to essentially transfer a radial bearing load to a housing, when a radial deflection or deformation of the structure extending in the peripheral direction caused by the radial bearing load is within a predetermined limit. For this, the bearing holder comprises an inner portion and an outer portion. A shaft-shaped structure transferring the bearing load to the housing is arranged between the inner portion and the outer portion.

U.S. Pat. No. 6,224,533 B1 discloses a support apparatus for a centrifuge rotor that is provided between a frame element and a bearing holder and arranged such that the same absorbs relative movements between the centrifuge rotor and the frame element.

EP 2 800 913 B1 discloses a turbo machine comprising, among others, a bearing holder. The bearing holder is fixed to a first portion at a housing while a second portion is radially movable with respect to the first portion. The second portion is connected to a radial bearing and is configured to move axially to eliminate axial loads on the radial bearing.

EP 1 890 014 B1 discloses an arrangement for supporting a shaft of a vacuum pump with a housing having a first bearing and a second bearing. The first bearing generates forces in the direction of the shaft axis and has an axial stiffness. The second bearing is configured as roller bearing and is arranged in a bearing holder with axial and radial stiffness. The bearing holder is configured such that a stiffness in axial direction is greater than a stiffness in radial direction, wherein the axial stiffness of the bearing holder is greater than the one of the first bearing.

DE 10 2016 212552 A1 discloses an electric compressor configured as impeller compressor operated by an electric motor for arrangement in a charging system of a combustion engine. Here, a compressor impeller and a rotor are arranged on a common rotor shaft and connected to the rotor shaft in a torque-proof manner. The rotor shaft is only rotatably supported in an area between compressor impeller and rotor by means of a bearing arrangement around the rotor rotational axis, wherein the bearing arrangement is received in a bearing reception of a single-part bearing reception housing part and at least one vibration-damping component is arranged between the bearing arrangement and the bearing reception.

WO 2018 181 186 A1 discloses a bearing structure having a rotary shaft, a bearing arranged in a housing such that the same supports the rotary shaft with respect to a housing. Further, the bearing structure includes an inner race through which the rotary shaft is introduced, and an outer race having a ring-like groove portion formed at an outer circumferential surface that is facing an inner wall area of the housing. Additionally, the bearing structure includes an O-ring arranged at the groove portion of the outer race of the bearing projects to the outside in a radial direction with respect to the outer circumferential surface and comes into contact with the inner wall area of the housing. A gap is formed between the inner wall area of the housing and the outer circumferential surface of the bearing. The gap is greater than a radial offset amount of the O-ring.

JP 2017 166 553 A discloses a bearing apparatus having a bearing, a bearing holder and an elastic element, wherein the bearing has a horizontal axis and is provided for supporting a shaft running in horizontal direction.

A general problem in bearing holders for electric motors and in particular for electric motors operated at high speed are heating and vibrations occurring in the area of the bearing. Typically, contact bearings are used, such as ball bearings or roller bearings. In such contact bearings, friction occurs, which results in power dissipation. This power dissipation is, on the one hand, problematic in that the same has to be dissipated and on the other hand problematic in that the same increases the wear of the bearing when the same is not or not sufficiently dissipated and hence reduces the lifetime of the bearing and the entire electric motor. At the same time, the problems with imbalances become greater the greater the speeds of the electric motors are, as the bearing holder as such starts to vibrate. This means that vibrations occur in such contact bearings at high speed, which have to be attenuated so that the bearing holder is subject to a lower mechanical load. Otherwise, the lifetime of the bearing and the entire electric motor is also reduced. Generally, the power dissipation increases more and more the higher the speeds are and the higher the imbalance are.

However, high speeds are needed to operate a heat pump using water as operating medium, for example, with a reasonably acceptable volume. Water has the characteristic that it generates a lot of water vapor with respect to a specific volume of liquid water. This is advantageous for the entire efficiency of the heat pump. However, this high amount of vapor has to be dissipated and in particular be compressed. Therefore, compressor motors are needed that have to run at high speeds when the same should not become too large, for example with speeds of more than 50,000 rpm. However, in such fast running motors, the bearing power dissipation and finally the power lifetime is a problem. The faster the motor is operated, the more power dissipation it generates and the shorter its lifetime becomes. All these points are disadvantageous since a high power dissipation means that the efficiency of the electric motor is reduced. Above that, a reduced lifetime results in higher costs, or, on the other hand, in extreme demands on the components to still obtain a sufficient lifetime, as the components and, in particular, the bearings have to endure the high power dissipation with low wear.

### SUMMARY

According to an embodiment, a bearing holder may have: an inner portion and an outer portion; wherein the inner portion includes a receiving contour for receiving the bearing and the outer portion is configured to be mounted on a housing, wherein a transition area between the inner portion and the outer portion includes a spring, wherein the transition area is at least partly in a plane perpendicular to an axial axis of the receiving contour and is at least partly in a plane with at least one part of the inner and the outer portion, wherein the transition area includes an attenuator and the attenuator is configured to attenuate a vibration of the inner portion to reduce a transfer of the vibration from the inner portion to the outer portion.

According to another embodiment, an electric motor may have: a motor casing; a motor shaft with a first end and a second end; an inventive bearing holder that is coupled to the motor casing; a bearing portion for supporting the motor shaft with the bearing holder; an element to be driven that is mounted on or close to an end of the motor shaft; a drive portion that is arranged between the bearing portion and the element to be driven and includes a rotor and a stator.

According to another embodiment, a method for producing a bearing holder with an inner portion and an outer portion, wherein the inner portion includes a receiving contour for receiving a bearing and the outer portion is configured to be mounted on a housing and includes a spring in a transition area between the inner portion and the outer portion, may have the steps of: arranging the transition area at least partly in a plane perpendicular to an axial axis of the receiving contour and at least partly in a plane with at least one part of the inner and the outer portion; and arranging an attenuator in the transition area, wherein the attenuator attenuates a vibration of the inner portion and reduces a transfer of the vibration from the inner portion to the outer portion.

According to another embodiment, a method for operating a bearing holder with an inner portion and an outer portion and a spring and an attenuator in a transition area between the inner portion and the outer portion, may have the steps of: receiving a rotor by a bearing in a receiving contour in the inner portion, attaching the outer portion at a housing that is operatively connected to the rotor, setting the rotor in motion, such that vibrations occur and attenuating occurring vibrations to reduce transfer of the vibration from the inner portion to the outer portion.

According to another embodiment, a bearing holder may have: an inner portion and an outer portion; wherein the inner portion includes a receiving contour for receiving the bearing and the outer portion is configured to be mounted on a housing, wherein a transition area between the inner portion and the outer portion includes a spring, wherein the transition area is at least partly in a plane perpendicular to an axial axis of the receiving contour and is at least partly in a plane with at least one part of the inner and the outer portion, wherein the transition area includes an attenuator and the attenuator is configured to attenuate a vibration of the inner portion to reduce a transfer of the vibration from the inner portion to the outer portion, wherein the spring is formed by a first and a second straight contour and the spring includes a ridge between the first and the second contour, such that the ridges form spokes, wherein the bearing holder includes up to six, advantageously three, springs symmetrically distributed around the axial axis.

The bearing holder according to the present technical teaching includes an inner portion and an outer portion, wherein the inner portion comprises a receiving contour for receiving a bearing and the outer portion is configured to be mounted on a housing. A transition area between the inner portion and the outer portion comprises a spring. Here, the transition area is at least partly in a plane perpendicular to an axial axis of the receiving contour and at least partly in a plane with at least one part of the inner and the outer portions. Further, the transition area comprises an attenuator and the attenuator is configured to attenuate a vibration of the inner portion to reduce or even entirely eliminate a transfer of the vibration from the inner portion to the outer portion.

The spring provided in the transition area can include several spring elements, wherein each spring element is to be considered as one spring. The springs are arranged along a circumference in the transition area between the inner and outer portions. Advantageously, the springs are formed along a transition surface. The springs are configured in a flat manner. Here, flat is to be considered such that the springs extend in a plane perpendicular to the axial axis of an inserted rotor. When the springs are vibrated, for example by movement of the rotor, the springs vibrate in the plane perpendicular to the axial axis.

The transition area includes a transition volume and hence a plurality of transition planes, which extends starting from a lower area of a cover plate up to an upper area of a cover plate between the inner portion and the outer portion. The transition volume includes the spring or the springs. Here, the transition area or the transition volume includes a plurality of transition planes that are perpendicular to the axial axis. In other words, the transition volume forms a gap between the inner portion and the outer portion. Consequently, the springs can vibrate in the transition area and hence in the transition planes that are parallel to each other. Therefore, the transition volume or the transition area is defined by an outer circumference of the inner portion, by an inner circumference of the outer portion and by an upper and a lower area of two opposite cover plates. In other words, the transition area is at least partly in a plane perpendicular to an axial axis of the receiving contour and is at least partly in one plane with at least part of the inner and outer portions. Thus, the transition planes of the transition area are horizontally extending planes in which the spring or the springs vibrate. Even when the springs vibrate in the transition planes of the transition area, the spring or the springs extend(s) parallel to the axial axis, in particular between the opposite cover plates. Each individual spring is a three-dimensional structure, wherein the vibration of a spring takes place in a plane parallel to the axial axis.

The transition volume or the transition area are flooded with a coolant, such as water or a refrigerant. Thereby, on the one hand, each spring can be attenuated and, on the other hand, at the same time heat can be dissipated from the spring via the coolant. The transition volume forms a gap between the inner and the outer portion. During operation, the coolant is continuously introduced in the transition area and dissipated again from the transition area. In other words, the transition area comprises an attenuator, namely for example the coolant in the transition area and the attenuator is configured to attenuate a vibration of the inner portion to reduce a transfer of the vibration from the inner portion to the outer portion. Here, the vibrations of the individual springs are to be allocated to the inner portion, since a vibration from a moving rotor is first transferred to the inner portion such that the springs start to vibrate.

The receiving contour for receiving a bearing in which a rotor can be introduced advantageously has a hollow cylinder shape. By the hollow cylinder shape, a bearing can be introduced into the bearing holder. However, the receiving contour can also have another geometry than the cylinder shape. It is important that the hollow area of the receiving contour can receive a bearing. Accordingly, the hollow area of the receiving contour is configured in a complimentary manner to an outer circumference of the bearing.

The suggested bearing holder allows decoupling of the occurring vibration by means of a spring arrangement or a contour arrangement that can be implemented in a small installation space.

The suggested bearing holder can be mounted to a housing of a turbo compressor or a cooling device. Generally, the suggested bearing holder can be mounted to devices including rotating shafts, spindles or a rotor to hold the same. In other words, the suggested bearing holder can be used anywhere where vibrations occur that have to be decoupled or attenuated from another element, frequently the device itself. With the suggested bearing holder, the lifetime of the bearing holder can be improved. On the one hand, with the suggested bearing holder, a vibration can be attenuated and, at the same time, heat occurring or resulting in the area of the bearing holder can be dissipated. With the suggested bearing holder, attenuation and heat dissipation can take place in a compact manner in a limited space. Here, the means for attenuating (coolants, springs and/or elastomer in the transition area) a vibration and the means for heat dissipation (coolant and/or elastomer in the transition area) are used in a synergetic manner, whereby the bearing holder as such has a smaller dimension, i.e., extension compared to bearing holders known from conventional technology. In particular, an extension along the axial axis of the rotor is smaller, whereby a transfer surface between rotor and bearing holder becomes smaller. By decoupling the quickly rotating system, for example a rotor of a radial turbo compressor from the housing, noise development and load on the bearing can be reduced, which increases the lifetime of the bearing holder or the rotating system as such.

With the bearing holder suggested herein, predetermined degrees of attenuation can be obtained or implemented, such that, among others, bending-critical frequencies of the system in which the bearing holder is installed can be set in specific ranges depending on the planned operating range of the system or the electric motor.

A further aspect of the present technical teaching relates to an electric motor where a rotor is operatively connected to the suggested bearing holder. An electric motor configured with the suggested bearing holder can, for example, be operated at high speed as the bearing holder is configured to reduce and, at best, eliminate vibrations. Hereby, the lifetime of an electric motor or the period where maintenance should take place can be prolonged.

A further aspect of the present technical teaching relates to a method for producing the bearing holder where a bearing holder can be modelled and produced matched to the power that an electric motor, in which the bearing holder is installed, is to deliver. The suggested bearing holder can be produced with cost-effective methods, such as 3D laser cutting or water jet cutting. However, it would also be possible to produce the suggested bearing holder by means of wire eroding or milling. When producing the bearing holder, for example, the radial and axial difference, can be well adjusted via the material strength and/or the cutting pattern by which the springs are formed. A further aspect of the present technical teaching relates to a method for operating the bearing holder, in particular after its production.

### BRIEF DESCRIPTION OF THE DRAWINGS

Embodiments of the present invention will be detailed subsequently referring to the appended drawings, in which:

FIG. 1 is a bearing holder known from conventional technology,

FIG. 2a is a bearing holder with indicated outer portion,

FIG. 2b is an enlargement of a section of the bearing holder according to FIG. 2a,

FIG. 3 is a bearing holder according to the technical teaching suggested herein,

FIG. 4 is another perspective of the bearing holder according to FIG. 3,

FIG. 5a is a perspective view of a bearing holder according to the technical teaching suggested herein,

FIG. 5b is a top view of the bearing holder according to FIG. 5a,

FIG. 6 is an enlargement of a section of the bearing holder according to FIGS. 3 and 4,

FIG. 7 is a perspective view of a bearing holder according to the technical teaching suggested herein,

FIG. 8 is a top view of the bearing holder according to FIG. 7, and

FIG. 9 is a schematic illustration of an electric motor in a turbo compressor having a bearing holder according to the technical teaching suggested herein.

### DETAILED DESCRIPTION OF THE INVENTION

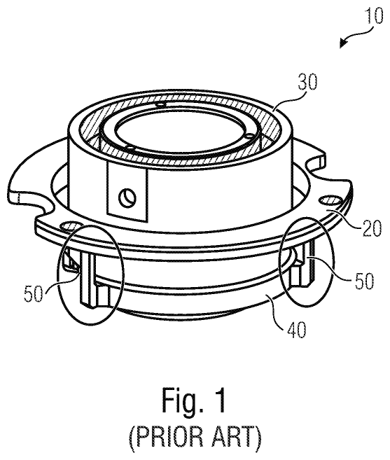

Individual aspects of the technical teaching described herein will be described below in FIGS. 1 to 9. In the present application, the same reference numbers relate to the same or equal elements, wherein not all reference numbers are illustrated again in all drawings as long as they are repeated.

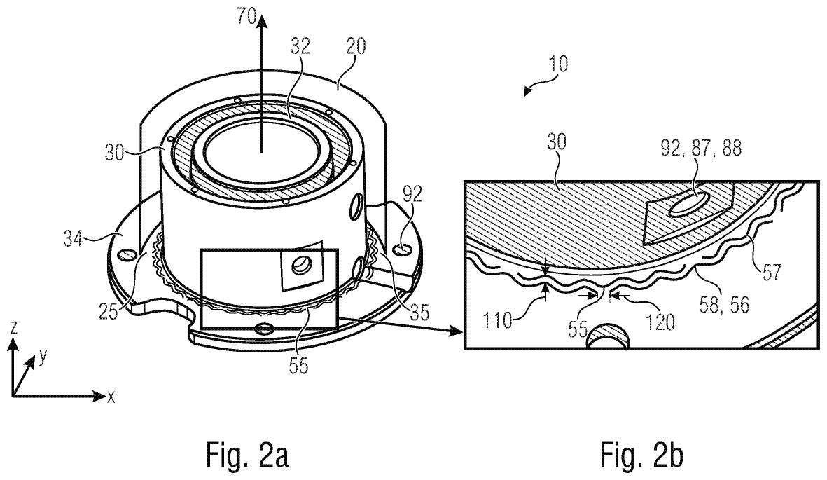

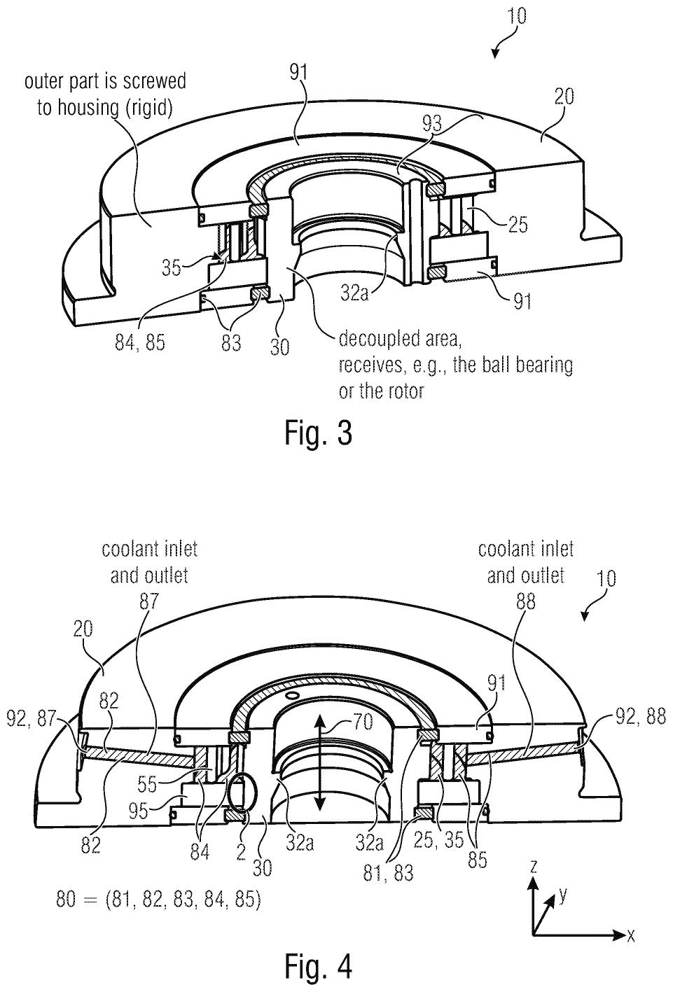

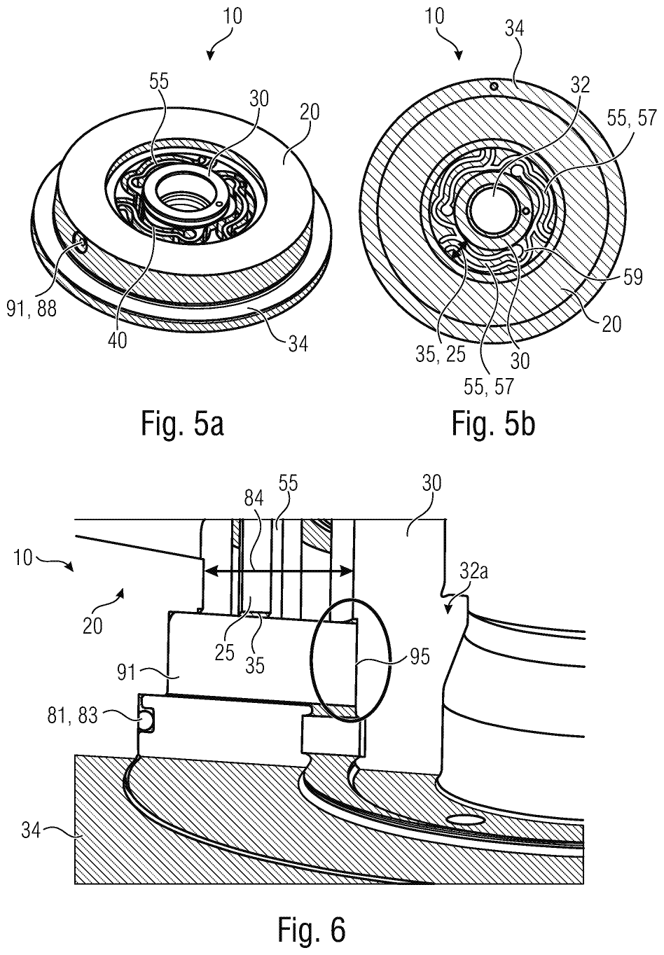

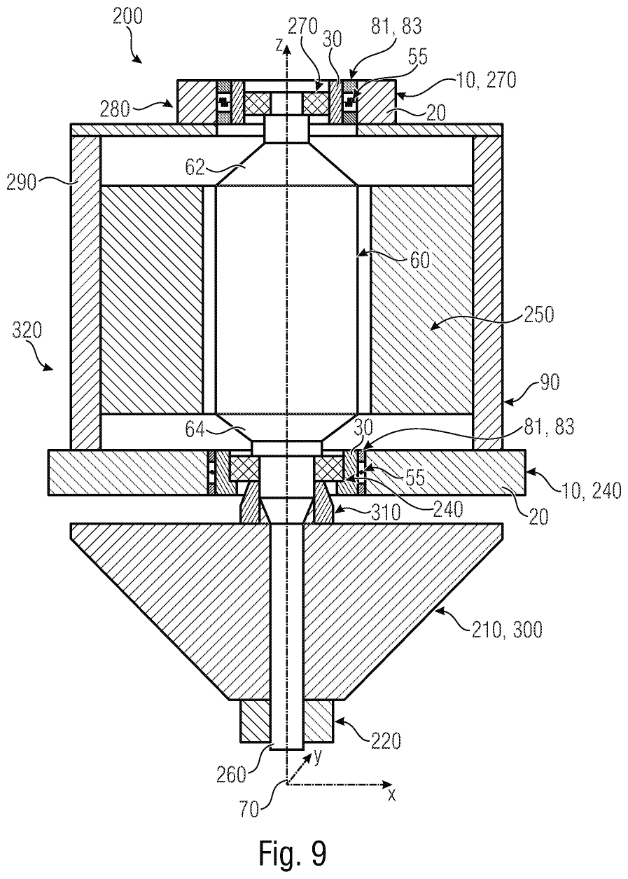

FIGS. 2 to 5 and FIGS. 7 to 8 each show one bearing holder. The bearing holder known from DE 10 2016 203 411 A1 shown in FIG. 1 has already been described in the introductory part of the application. The bearing holders 10 shown in FIGS. 3 to 5 and 7 and 8 each comprise an inner portion 30 and an outer portion 20; wherein the inner portion 30 comprises a receiving contour 32 for receiving a bearing, which can again be used for receiving a rotor (not illustrated). As shown, for example in FIG. 2 and FIG. 5, a receiving contour 32 for receiving a bearing is arranged within the inner portion 30. In all other figures with the exception of FIG. 9, such a receiving contour can also be seen, wherein the same is not provided with reference number in order to not overload the individual figures. The bearing holder 10 illustrated in FIG. 2 completely shows the inner portion 30 while the outer portion 20 is only partly illustrated in a schematic manner. As can be seen FIGS. 2 to 5 and 7 to 8, the receiving contour 32 can be configured as a hollow cylinder comprising a relief 32a for receiving the bearing. The outer portion 20 is configured to be mounted on a housing, in particular of a turbo compressor or a cooling device. For this, bores 92 are provided at a base 34 that can be part of the outer portion 20, such that the outer portion 20 can be mounted to the housing 90. For example, the outer portion can be screwed onto the housing 90. In such a case, the bores 92 can be threaded.

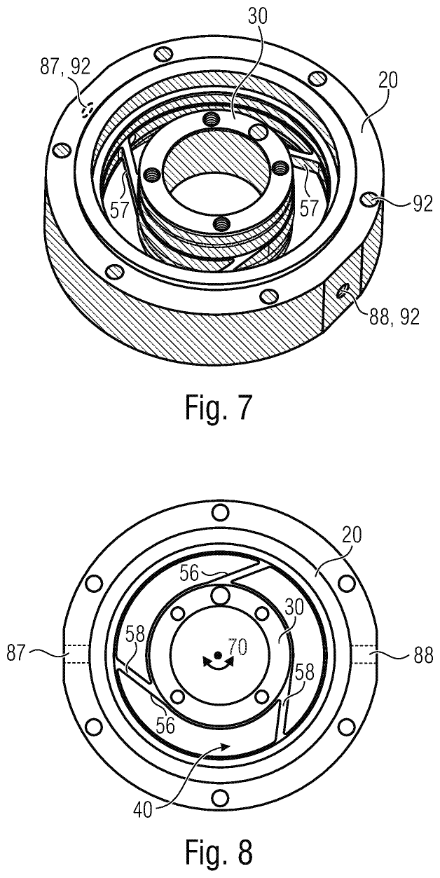

The area between the outer portion 20 and the inner portion 30 defines a transition area 25. The transition area 25 comprises a transition surface 35 that couples the inner portion 30 and the outer portion 20, in particular connects the same. The transition area 25 between the inner portion 30 and the outer portion 20 comprises a spring 55. Here, the spring 55 can also be provided as spring arrangement 40 of several springs 55 as, for example, shown in FIGS. 2, 5, 7 and 8. Further, the spring 55 can comprise straight contours 56, such that the ridges 57 formed by the contours 56 form spokes 58 as shown in FIGS. 7 and 8. Alternatively, the spring 55 can comprise bent contours 56, such that the ridges 57 formed by the contours 56 have a bent course 59. The bent course 59 can be wave-shaped as shown in FIGS. 2a and 2b, which has a periodicity like in a sine wave. In that case, the course of the wave defines the ratio of the radial to axial stiffness of the resulting spring 55. Alternatively, the bent course 59 can run such that ridges 57 are configured in a bent pattern that does not have a periodicity like a sine wave as shown, for example, in FIGS. 5a and 5b. FIG. 2b shows three springs 55. For example, the three springs 55 shown in FIGS. 5a and 5b each only show one period of the bent course 59. FIGS. 5a and 5b also show three springs 55 with ridges 57, wherein each spring 55 has a non-periodical bent course 59. The three springs according to FIGS. 7 and 8 are configured as spokes 58 with a straight contour 56 forming the ridges 57.

Here, each spring 55 is formed by a first contour 56 and the second contour 56, wherein the first contour 56 and the second contour 56 each form a ridge 57. The ridges 57 are connected to the inner portion 30 at a first end and connected to the outer portion 20 at a second end. The ridges 57 forming the springs 55 are configured in the transition surface 35 in the transition area 25. Thus, the transition area is at least partly in a plane perpendicular to an axial axis 70 of the receiving contour 32 and is at least partly in a plane with at least one part of the inner and the outer portion 20, 30.

As can be seen in FIGS. 2 to 5 and FIGS. 7 and 8, the springs 55 are symmetrically distributed around the axial axis 70 between the inner portion 30 and the outer portion 20. In particular, the springs 55 are distributed in a plane perpendicular to the axial axis 70. The plane perpendicular to the axial axis 70 is, for example, spanned by an x-y plane, while the axial axis 70 runs longitudinally to a z direction. In such a case, the springs 55 vibrate in the x-y plane with deflections in the x-y plane. Up to six, advantageously three, springs 55 can be arranged symmetrically distributed around the axial axis 70. The spring 55 or the springs 55 extend(s) in the transition area 25 and is/are configured to vibrate in a plane, in particular an x-y plane parallel to the transition surface 35. This is indicated in FIG. 2b, for example by arrows 110 and 120. The x-y plane(s) define(s), for example, horizontal plane(s).

Further, the transition area 25 comprises an attenuator 80 as can be seen in FIGS. 3 and 4. The attenuator 80 is configured to attenuate a vibration of the inner portion 30 to reduce a transfer of the vibration from the inner portion 30 to the outer portion 20. In the ideal case, the vibrations are not only attenuated but also eliminated. Attenuation or elimination can occur in particular at vibrations with very high frequencies. The vibration of the individual springs 55 is to be allocated to the inner portion 30 as the vibration from a moving rotor (not illustrated) is first transferred to the inner portion 30, such that the springs 55 start to vibrate. The springs 55 start to vibrate in the transition surface 35, i.e., in the x y plane or in particular in a horizontal plane.

The attenuator 80 includes an elastomer 81 and/or a crimping liquid attenuator 82. The crimping liquid attenuator 82 includes a crimping fluid 85 that is continuously supplied into a gap 84, for example, during operation and can be dissipated from the gap 84. The elastomer 81 can be configured in the shape of O-rings 83 or also rectangular rings that are also K-rings. The elastomer 81 can be arranged, for example, at different positions. This means that a number of O-rings 83 or K-rings can be provided to provide, for example, a seal or an attenuation in particular of the inner portion 30. The inner portion 30 and the outer portion 20 are spaced apart by the gap 84 in which the crimping liquid attenuator 82 is arranged. The gap 84 defines a transition volume. In other words, the gap 84 spans a transition volume extending parallel to the axial axis 70 starting from the transition surface 35. The crimping liquid attenuator 82 can also be a crimping fluid attenuator, i.e., a crimping fluid 85, in particular when a gas is used in the attenuator 82 instead of a liquid. In both cases, a crimping fluid is introduced in the transition volume of the gap 84. In other words, the crimping liquid attenuator 82 for attenuating vibrations is filled with a crimping fluid 85. Advantageously, the crimping fluid 82 is a liquid. However, it is also possible to use a gas as crimping fluid. It is advantageous when the crimping fluid 85 is suitable to attenuate vibrations and to dissipate heat. The crimping fluid 85 operates as a coolant, which can additionally attenuate vibrations. The coolant can be a plant medium, such as a refrigerant or water.

The transition volume of the crimping liquid attenuator 82 is configured as the gap 84 between the inner and the outer portion 20, 30, wherein cooling liquid can be supplied continuously during operation of the bearing holder 10 to attenuate vibrations and to dissipate heat. Continuously supplying and dissipating the coolant or the crimping fluid 85 in and out of the gap 84 can take place via a coolant inlet 87 and a coolant outlet 88. The gap 84 of the crimping liquid attenuator 82 is sealed with the elastomer 81, which is at the same time configured to attenuate the occurring vibrations and/or to absorb heat. When absorbing heat, the elastomer 81 and the material surrounding the elastomer expand according to their coefficients of expansion.

FIGS. 3 and 4 show, for example, that the elastomer 81 in the form of O-rings 83 is arranged at different positions. For example, one O-ring 83 each is provided at the upper and lower transition between the upper or lower cover plate 91 and the inner portion 30. Additionally, for example one O-ring 83 each is provided at the upper and lower transition between the upper or lower cover plate 91 and the outer portion 20.

Further, FIG. 4 shows a transition between a lower cover plate 91 and the inner portion 30 comprising a further cover gap 95. The cover gap 95 is highlighted by a border 2 in FIG. 4 in enlarged illustration in FIG. 6. The cooling liquid can enter the cover gap 95. The liquid entered into the cover gap 95 can support the attenuation of the vibrations during operation on the one hand and, on the other hand, the cooling liquid can simultaneously cool the O-ring 83 or the elastomer 81 and/or the outer circumference of the inner portion 30. Consequently, the elastomer 81 is configured as elastic O-ring 83 and arranged at an outer circumference of the inner portion 30. Further, the elastomer 81 is configured as an elastic O-ring 83 and arranged at an inner circumference of the outer portion 30.

It is further possible that the crimping liquid attenuator 82 comprises a cooling gas or a permanent cooling liquid that is introduced into the gap 84, sealed by means of the elastomer 81, during production of the bearing holder 10. If a permanent cooling liquid or even no cooling liquid but a cooling gas is provided in the gap 84, no coolant inlet 87 and no coolant outlet 88 has to be provided. Rather, the permanent cooling liquid or the cooling gas is introduced into the gap 84 during the production of the bearing holder 10 and closed, in particular sealed, by means of the cover blades 91 and the elastomer 81.

FIGS. 2, 5, 7 and 8 show that the spring 51 and one or several further springs 55 are arranged in the transition area 25 that is configured in an annular shape and encloses the crimping liquid attenuator 82. Advantageously and according to FIGS. 5, 7 and 8, three springs 55 are arranged in the transition area 25.

FIGS. 3 and 4 show how cover plates 91 are arranged in an interlocking manner between the inner and the outer portion 30, 20 and how an end of the outer portion 20, an end of the inner portion 30, the elastomer 81 and an area of the cover plate 91 form a planar surface 93. Here, the cover plates 91 extend perpendicular to the axial axis 70. The cover plates 91 are spaced apart from each other by an extension of the springs 55 parallel to the axial axis 70. This determines a volume of the crimping liquid attenuator that corresponds to the volume of the gap 84. A volume of the crimping liquid attenuator 82, in which the coolant can be introduced via the at least one coolant inlet 87 is spanned by an outer circumference of the inner portion 30 and an inner circumference of the outer portion 20 as well as by at least one cover plate 91 arranged at the ends of the inner and outer portion 20, 30.

Advantageously, the outer portion 20 comprises a coolant inlet 87 and a coolant outlet 88, wherein the coolant inlet 87 is provided for suppling a coolant between the inner and outer portions 20, 30. In other words, the coolant inlet 87 is provided for supplying a coolant in the transition area or in the crimping liquid attenuator. The coolant outlet 88 is provided for dissipating the coolant between the inner and the outer portion 20, 30. Advantageously, a single coolant inlet 87 and a single coolant outlet 88 are provided, which can be arranged diametrically to each other. It is further possible that the single coolant inlet 87 and the single coolant 88 are arranged at two positions of the annular shape of the outer portion 20 such that the single coolant inlet 87 and the single coolant outlet 88 span an angle between 90° and 175°. It is further possible that more than one coolant inlet 87 and more than one coolant outlet 88 are provided in the outer portion 20 (see FIGS. 4, 5, 7 and 8). The same are then, for example, arranged symmetrically on the annular shape. For example, an even number of coolant inlets 87 and an even number of coolant outlets 88 can be provided. Advantageously, two coolant inlets 87 and two coolant outlets 88 can be provided, wherein the coolant inlets 87 are arranged diametrically with respect to each other and wherein the coolant outlets 88 are arranged diametrically with respect to each other. A coolant inlet 87 and a coolant outlet 88 can be configured by a bore 92 or by a recess 94. FIG. 2 shows the coolant inlet 87 or the coolant outlet 88 as recess 94 that can also be arranged in the inner portion. FIGS. 4, 5, 7 and 8 show the coolant inlet 87 or the coolant outlet 88 as bore 92. The bores or recesses can be configured, for example, with a thread, in particular milled, such that depending on the requirements, the coolant inlet 87 and/or the coolant outlet 88 can be closed by screwing in a screw.

Advantageously, at least part of the coolant inlet 87 and at least part of the coolant outlet 88 and the spring 55 are in at least one cross-sectional plane perpendicular to the axial axis 70 of the receiving contour 32. Thereby, the bearing holder 10 can be structured in a more compact manner. In particular, the suggested bearing holder 10 has a smaller extension along the axial axis 70 compared to the bearing holders known from conventional technology. Thus, it can be the case, for example, that the suggested bearing holder has, with the same stiffness as in a conventional bearing holder, an extension that is essentially four times smaller than the one of the conventional bearing holder. Consequently, the abutment area of an introduced ball bearing into which a rotor (not illustrated) is introduced is smaller. This results again in less friction between rotor and bearing holder, whereby power dissipation of the rotor or the electric motor can be reduced.

Advantageously, the inner portion 30, the outer portion 20, the spring 55, the elastomer 81 and the crimping liquid attenuator 82 or the attenuator 80 are configured such that, when vibrations occur, in particular at frequencies from 40 Hz onwards or between 40 and 1000 Hz, the inner portion is decoupled from the outer portion. It is particularly advantageous when the inner portion 30 is decoupled from the outer portion 20 when vibrations in the frequency range of the inherent vibration of the rotor occur. Thereby, it can be prevented that the bearing holder or electric motor is destroyed. In attenuated systems, an inherent vibration can correspond to a possible resonance vibration. However, resonance vibrations should be prevented to prevent destruction of the electric motor.

Further, the base 34 can be seen in FIGS. 2 to 5 and FIGS. 7 and 9. Advantageously, the base 34 comprises bores through which the bearing holder 10 can be mounted, in particular screwed, to a housing 90 (only shown in FIG. 9).

FIG. 9 shows a schematic illustration of a compressor including a suggested electric motor and the suggested bearing holder 10. The suggested electric motor includes a motor casing 290, which is a housing 90 for the electric motor. Additionally, the electric motor comprises a motor shaft 260 with a first end and a second end. Additionally, the suggested electric motor includes a bearing holder 10, in particular a first one that is described herein, that is coupled to the motor casing 290 or the housing 90 of the electric motor. Advantageously, the bearing holder 10 is screwed to the motor casing 290. In particular, a first bearing holder 10 is arranged at or close to the first end of the motor shaft 260, wherein the first end of the motor shaft is equal to a first rotor end 62. For attaching the bearing holder 10 to the housing 90, the base 34 of the bearing holder 10 comprises bores 92.

Additionally, the electric motor comprises a bearing portion 280 for supporting the motor shaft 260 or a rotor 60 with the bearing holder 10. Further, the electric motor comprises an element to be driven 300 that is mounted on or close to in particular a second end of the motor shaft. The second end of the motor shaft 260 does not correspond to a second rotor end 64. The element to be driven 300 is mounted, as can be seen in FIG. 9, between the second rotor end 64 and the second end of the motor shaft 260. The element to be driven 300 can, for example, be an impeller or another element known to the person skilled in the art. The element to be driven 300 can be secured to the motor shaft 260 with a shaft nut 220 at the second end of the motor shaft.

A drive portion 320 is arranged between the bearing portion 280 and the element to be driven 300 and comprises a rotor 60 and a stator 250. The stator 250 and the rotor 50 of the motor shaft 260 are enclosed by the housing 90 as can be seen, for example, in FIG. 9. The element to be driven 300, which is arranged on one, in particular the second, end on the motor shaft 260 is spaced apart from a further, in particular second, bearing holder 10 by one or several distance sleeves 310. The first bearing holder 10 is arranged at the first rotor end 62 and the second bearing holder 10 is arranged at the second rotor end 64. In other words, a further, i.e., second, bearing holder 10 described herein is arranged between the drive portion 320 and the element to be driven 300. The drive portion 320 is arranged between the first bearing holder 10 and the second bearing holder 10, i.e., a bearing holder 10 and a further bearing holder 10. The further bearing holder 10 can, for example, be coupled to a fixed bearing 240 of the rotor 60 with its inner portion 30. The first bearing holder 10 can be coupled to a movable bearing 270 with its inner portion 30. The springs 55 of the bearing holder 10 are schematically illustrated in FIG. 9, wherein the bearing holders comprise the springs 55 described herein, as shown, for example, in FIGS. 2 to 5 and 7 and 8.

A further aspect of the present technical teaching relates to a method for producing bearing holder 10 having an inner portion 30 and an outer portion 20, wherein the inner portion 30 comprises a receiving contour 32 for receiving a bearing where a rotor 60 can be received and the outer portion 20 is configured to be mounted on a housing 90, and a spring 55 in a transition area 25 between the inner portion 30 and the outer portion 20. The method for producing a bearing holder 10 includes arranging the transition area 25 at least partly in a plane perpendicular to an axial axis 70 of the receiving contour 32 and at least partly in a plane with at least one part of the inner and the outer portion 20, 30. The bearing holder 10 can consist, for example, of a single-part element including the inner and the outer portion 20, 30. Arranging the transition area 25 that comprises springs 55 and that is arranged between the inner and the outer portions 20, 30 can, for example, be performed by 3D laser cutting or water jet cutting. Contours 56 forming the spring 55 can be cut in the transition area 25 by 3D laser cutting or by water jet cutting. Further, the method for producing a bearing holder 10 includes arranging an attenuator 80 in the transition area 25, wherein the attenuator 80 attenuates a vibration of the inner portion 30 and thereby reduces a transfer of the vibration from the inner portion 30 to the outer portion 20. Advantageously, the springs 55 and the elastomer 81 or the attenuator 80 of the bearing holder 10 are matched to each other regarding their characteristics such that vibrations, in particular at specific frequencies, can be eliminated.

Here, the method for producing a bearing holder 10 further comprises predetermining an intensity of an attenuation and/or heat dissipation of the occurring vibrations; and determining a geometry and a coolant composition of the crimping liquid attenuation 82 included in the attenuator 80. Additionally, the method comprises a step of determining a geometry and composition of the spring 55. Depending on the predetermined intensity of the attenuation, for example, the shape of the spring 55 can be different and/or the number of springs 55 can be different. Further, the method includes selecting a suitable elastomer 81 that is matched to the predetermined intensity of the attenuation with its physical characteristics. For this, the method includes the step of determining an elastomer that is configured for attenuating vibrations. After all these steps of determining have been performed or after each individual step of determining has been performed, the steps of producing can be performed together or each step of producing can be performed individually. In other words, producing the determined crimping liquid attenuator and/or the determined spring and/or the determined elastomer only take place after the desired characteristics of the stated components have been determined. Thereby, a bearing holder that is matched to the specific conditions where the bearing holder 10 is used can be produced. After the individual components have been determined and produced, the step of assembling the bearing holder 10 is performed, which includes the determined crimping liquid attenuator, the determined spring and the determined elastomer, wherein the bearing holder 10 attenuates a vibration in the predetermined intensity and/or dissipates heat in the predetermined intensity.

A further aspect of the present technical teachings relates to a method for operating a bearing holder 10 with an inner portion 30 and an outer portion 20 and a spring 55 and an attenuator 80 in a transition area 25 between the inner portion 30 and the outer portion 20. The method for operating a bearing holder 10 includes the steps of receiving a rotor 60 by the inner portion 30, in particular by a bearing in the receiving contour 32 at the inner portion 30 and attaching the outer portion 20 at a housing 90 that is operatively connected to the rotor 60. Here, the steps of receiving and matching can also be in a different order. After the steps of receiving and mounting have been performed, the rotor 60, that is operatively connected to the bearing holder 10, can be set in rotation, i.e., in motion. For this, the step of setting the rotor in motion is provided, such that vibrations can occur. Due to the previously determined bearing holder 10 with its determined intensity of attenuation, the step of attenuating occurring vibrations to reduce transfer of the vibration from the inner portion 30 to the outer portion 20 takes place automatically by the used bearing holder 10, i.e., without any further action from outside.

Depending on the situation, vibrations of different frequencies and different amplitudes occur, wherein a bearing holder 10 can be modelled with respect to the specific situation during a method of producing the bearing holder 10 in dependence on the situation. In other words, a bearing holder 10 described herein can, at first, be produced with the method described herein for producing a bearing holder 10 to subsequently use the bearing holder 10 in a method for operating a bearing holder 10 suggested herein wherein its functionality can be used.

For the bearing holder 10 suggested herein, up to three mechanisms for specific attenuation or decoupling of the vibrations between the outer and the inner portion 20, 30 are disclosed namely:
a) Decoupling by means of a spring 55 that is formed by contours 56 and is in a plane perpendicular to the axial axis 70 of the rotor 60.
b) Decoupling my means of a crimping liquid attenuator 82, wherein an intensity of the attenuation can be adjusted via a width of the gap 84 and/or a component height of the bearing holder 10. Additionally, circulating plant water can be used as medium for attenuating.
c) Decoupling by means of elastomers 81.

These three mechanisms a) to c) can be used together or separately, or two of the three mechanisms can be used for decoupling the vibrations of the system. If, for example, only two mechanisms are used, an attenuation or decoupling by means of elastomers 81 and by means of a crimping liquid attenuator 82 can be provided. Alternatively, attenuation merely by elastomers 81 could be provided.

It is particularly advantageous to use all three mechanisms, since this can reduce vibrations of the system in a synergetic manner. In other words, the three presented mechanisms cooperate such that attenuation and heat dissipation are facilitated by the cooperation of the three mechanisms in addition to the additive superposition of the three mechanisms. The three mechanisms can each individually be performed to a stronger or weaker manner during producing the suggested bearing holder 10, whereby attenuation and/or heat dissipation can be specifically controlled.

A further advantage of the suggested bearing holder 10 is that water that can be introduced as crimping liquid via the coolant inlet 87 into the crimping liquid attenuator 82 and can be dissipated again via the coolant outlet 88 from the crimping liquid attenuator 82 can be used as refrigerant or plant medium. Additionally, the bearing holder 10 can simultaneously be cooled by the water or the refrigerant, i.e., the refrigerant is used for heat dissipation. Again, by cooling the bearing holder 10 the ball bearings resting against the bearing holder 10 can be cooled. Otherwise, due to the low water vapor atmosphere, the heat in the vacuum can hardly be dissipated for the bearing holder 10.

As already described, the springs 55 are produced by means of 3D laser cutting or water jet cutting. This allows a very precise toleration and orientation of the members advantageously consisting of metal.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1. Bearing holder, comprising:
an inner portion and an outer portion; wherein
the inner portion comprises a receiving contour for receiving the bearing and
the outer portion is configured to be mounted on a housing, wherein
a transition area between the inner portion and the outer portion comprises a spring, wherein
the transition area is at least partly in a plane perpendicular to an axial axis of the receiving contour and is at least partly in a plane with at least one part of the inner and the outer portion, wherein the transition area comprises an attenuator and the attenuator is configured to attenuate a vibration of the inner portion to reduce a transfer of the vibration from the inner portion to the outer portion.

2. Bearing holder according to claim 1, wherein the transition area comprises a transition surface that couples the inner portion and the outer portion to each other.

3. Bearing holder according to claim 2, wherein the spring extends in the transition area and is configured to vibrate in a plane parallel to the transition surface.

4. Bearing holder according to claim 1, wherein the spring is formed by a first and a second contour and the spring comprises a ridge between the first and the second contour.

5. Bearing holder according to claim 4, wherein the ridge is connected to the inner portion at a first end and is connected to the outer portion at a second end.

6. Bearing holder according to claim 4, wherein the spring comprises straight contours, such that the ridges form spokes, or comprises bent contours, such that the ridges comprise a bent course.

7. Bearing holder according to claim 1, comprising up to six, advantageously three, springs symmetrically distributed around the axial axis.

8. Bearing holder according to claim 1, wherein the attenuator comprises an elastomer and/or a crimping liquid attenuator.

9. Bearing holder according to claim 8, wherein the inner portion and the outer portion are spaced apart from each other by the crimping liquid attenuator, wherein the crimping liquid attenuator comprises a transition volume that extends parallel to the axial axis starting from the transition surface.

10. Bearing holder according to claim 8, wherein the crimping liquid attenuator for attenuating vibrations is filled with a crimping fluid.

11. Bearing holder according to claim 8, wherein the crimping liquid attenuator is a gap between the inner and the outer portion, into which cooling liquid can continuously be supplied during operation of the bearing holder to attenuate vibrations and to dissipate heat.

12. Bearing holder according to claim 8, wherein the gap of the crimping liquid attenuator is sealed with an elastomer that is simultaneously configured to attenuate the occurring vibrations.

13. Bearing holder according to claim 8, wherein the crimping liquid attenuator comprises a cooling gas or a permanent cooling liquid that is introduced into the gap, sealed by means of the elastomer, during production of the bearing holder.

14. Bearing holder according to claim 8, wherein the spring and one or several further springs are arranged in the transition area that is configured in an annular shape and encloses the crimping liquid attenuator.

15. Bearing holder according to claim 1, wherein the elastomer, configured as elastic O-ring or as elastic K-ring, is arranged at an outer circumference of the inner portion.

16. Bearing holder according to claim 1, wherein the elastomer, configured as elastic O-ring or as elastic K-ring, is arranged at an inner circumference of the outer portion.

17. Bearing holder according to claim 1, wherein cover plates are arranged in an interlocking manner between the inner and the outer portion, and an end of the outer portion, an end of the inner portion, the elastomer and an area of the cover plate form a planar area.

18. Bearing holder according to claim 1, wherein the outer portion comprises a coolant inlet and a coolant outlet, wherein the coolant inlet is provided for supplying a coolant between the inner and the outer portion.

19. Bearing holder according to claim 18, wherein at least part of the coolant inlet and at least part of the coolant outlet and the spring are perpendicular to the axial axis of the receiving contour in at least one cross-sectional plane.

20. Bearing holder according to claim 18, wherein the coolant is a plant medium, such as a refrigerant or water.

21. Bearing holder according to claim 18, wherein a volume of the crimping liquid attenuator is spanned by an outer circumference of the inner portion and an inner circumference of the outer portion as well as by at least one cover plate arranged on the ends of the inner and outer portion, into which the coolant can be introduced via the at least one coolant inlet.

22. Bearing holder according to claim 18, wherein the coolant inlet is arranged diametrically to the coolant outlet in the outer portion.

23. Bearing holder according to claim 18, wherein the at least one cooling inlet and the at least one coolant outlet are each configured as bore or as recess in the outer portion.

24. Bearing holder according to claim 1, wherein the inner portion, the outer portion, the spring, the elastomer and the crimping liquid attenuator are configured such that when vibrations occur, in particular at frequencies starting from 40 Hz or between 40 Hz and 1000 Hz, the inner portion 30 is decoupled from the outer portion 20.

25. Bearing holder according to claim 1, wherein the receiving contour for receiving the bearing is a hollow cylinder.

26. Electric motor, comprising:
a motor casing;
a motor shaft with a first end and a second end;
a bearing holder according to claim 1 that is coupled to the motor casing;
a bearing portion for supporting the motor shaft with the bearing holder;
an element to be driven that is mounted on or close to an end of the motor shaft;
a drive portion that is arranged between the bearing portion and the element to be driven and comprises a rotor and a stator.

27. Electric motor according to claim 26, wherein a further bearing holder, comprising:
an inner portion and an outer portion; wherein
the inner portion comprises a receiving contour for receiving the bearing and
the outer portion is configured to be mounted on a housing, wherein
a transition area between the inner portion and the outer portion comprises a spring, wherein
the transition area is at least partly in a plane perpendicular to an axial axis of the receiving contour and is at least partly in a plane with at least one part of the inner and the outer portion, wherein the transition area comprises an attenuator and the attenuator is configured to attenuate a vibration of the inner portion to reduce a transfer of the vibration from the inner portion to the outer portion
is arranged between the drive portion and the element to be driven.

28. Method for producing a bearing holder with an inner portion and an outer portion, wherein
the inner portion comprises a receiving contour for receiving a bearing and
the outer portion is configured to be mounted on a housing and comprises a spring in a transition area between the inner portion and the outer portion, the method comprising:
arranging the transition area at least partly in a plane perpendicular to an axial axis of the receiving contour and at least partly in a plane with at least one part of the inner and the outer portion; and
arranging an attenuator in the transition area, wherein the attenuator attenuates a vibration of the inner portion and reduces a transfer of the vibration from the inner portion to the outer portion.

29. Method according to claim 28, comprising:
predetermining an intensity of an attenuation and/or heat dissipation of the occurring vibrations;
determining a geometry and coolant composition of a crimping liquid attenuator;
determining a geometry and composition of the spring; and/or
determining an elastomer configured for attenuating vibrations;
producing the determined crimping liquid attenuator, the determined spring and/or the determined elastomer; and
assembling the bearing holder comprising the determined crimping liquid attenuator, the determined spring and the determined elastomer, wherein the bearing holder attenuates a vibration in the predetermined intensity and/or dissipates heat in the predetermined intensity.

30. Method according to claim 28, wherein contours of the spring are produced by 3D laser cutting or by water jet cutting.

31. Method for operating a bearing holder with an inner portion and an outer portion and a spring and an attenuator in a transition area between the inner portion and the outer portion, the method comprising:
receiving a rotor by a bearing in a receiving contour in the inner portion,
attaching the outer portion at a housing that is operatively connected to the rotor,
setting the rotor in motion, such that vibrations occur and
attenuating occurring vibrations to reduce transfer of the vibration from the inner portion to the outer portion.

32. Method according to claim 31, wherein a bearing holder, comprising:
an inner portion and an outer portion; wherein
the inner portion comprises a receiving contour for receiving the bearing and
the outer portion is configured to be mounted on a housing, wherein
a transition area between the inner portion and the outer portion comprises a spring, wherein
the transition area is at least partly in a plane perpendicular to an axial axis of the receiving contour and is at least partly in a plane with at least one part of the inner and the outer portion, wherein the transition area comprises an attenuator and the attenuator is configured to attenuate a vibration of the inner portion to reduce a transfer of the vibration from the inner portion to the outer portion
is used and its functionality is utilized.

33. Bearing holder, comprising:
an inner portion and an outer portion; wherein
the inner portion comprises a receiving contour for receiving the bearing and
the outer portion is configured to be mounted on a housing, wherein
a transition area between the inner portion and the outer portion comprises a spring, wherein
the transition area is at least partly in a plane perpendicular to an axial axis of the receiving contour and is at least partly in a plane with at least one part of the inner and the outer portion, wherein the transition area comprises an attenuator and the attenuator is configured to attenuate a vibration of the inner portion to reduce a transfer of the vibration from the inner portion to the outer portion, wherein
the spring is formed by a first and a second straight contour and the spring comprises a ridge between the first and the second contour, such that the ridges form spokes, wherein the bearing holder comprises up to six, advantageously three, springs symmetrically distributed around the axial axis.
